(19) United States
(12) Patent Application Publication
(10) Pub. No.: US 2026/0168526 A1
(43) Pub. Date: Jun. 18, 2026

(54) HANDLE HARDWARE FASTENER AND HARDWARE ASSEMBLY

(71) Applicant: LIBERTY HARDWARE MFG. CORP., Winston-Salem, NC (US)

(72) Inventor: Michael GLASER, Winston-Salem, NC (US)

(21) Appl. No.: 18/978,820

(22) Filed: Dec. 12, 2024

(51) Int. Cl. F16B 33/00; E05B 1/00

(52) U.S. Cl. CPC F16B 33/00; E05B 1/0015

(57) ABSTRACT

A handle hardware fastener is provided with a threaded shaft for threaded engagement with a threaded handle, with a length to extend through an aperture formed through a drawer or door, wherein at least one weakened region is formed in the threaded shaft to permit separation of an unused portion of the shaft from an installed portion of the shaft. A head is attached to the threaded shaft, the head has a width greater than a diameter of the shaft. The head has a first drive feature operable to be driven for rotation, a second drive feature operable to be driven for rotation, and a third drive feature operable to be driven for rotation. A method to install hardware is provided by installing the threaded shaft through the aperture. The threaded shaft is shortened at a weakened region outside of a threaded region adjacent the drawer or door.

### TECHNICAL FIELD

Various embodiments relate to handle hardware fasteners and hardware assemblies.

### BACKGROUND

Glaser U.S. Patent Application Publication No. US 2024/0352766 A1, discloses a hardware assembly and published to Liberty Hardware Mfg. Corp., on Oct. 24, 2024.

### SUMMARY

According to an embodiment, a handle hardware fastener is provided with a threaded shaft for threaded engagement with a threaded handle, with a length to extend through an aperture formed through a drawer or door, wherein at least one weakened region is formed in the threaded shaft to permit separation of an unused portion of the shaft from an installed portion of the shaft. A head is attached to the threaded shaft, the head has a width greater than a diameter of the shaft.

According to a further embodiment, the at least one weakened region is further defined as a transverse notch formed in the threaded shaft.

According to another further embodiment, the fastener is formed from a structural polymer.

According to another further embodiment, the head provides a first drive feature operable to be driven for rotation, and a second drive feature operable to be driven for rotation.

According to an even further embodiment, the head provides a third drive feature operable to be driven for rotation.

According to another even further embodiment, the first drive feature is further defined as: a slot sized to receive a flat head screwdriver, a pair of slots sized to receive a Phillips head screwdriver, or an external spline formed about the head.

According to an even further embodiment, the second drive feature is different than the first drive feature, and wherein the second drive feature is further defined as: a slot sized to receive a flat head screwdriver, a pair of slots sized to receive a Phillips head screwdriver, or an external spline formed about the head.

According to another even further embodiment, the head provides a third drive feature operable to be driven for rotation. The third drive feature is different than the first drive feature and the second drive feature. The third drive feature is further defined as: a slot sized to receive a flat head screwdriver, a pair of slots sized to receive a Phillips head screwdriver, or an external spline formed about the head.

According to another further embodiment, a washer is formed integrally with the head, the washer having a diameter greater than a diameter of the threaded shaft.

According to an even further embodiment, the head has a diameter greater than the diameter of the shaft and less than the diameter of the washer.

According to another further embodiment, the weakened region is further defined as one or more weakened regions.

According to another embodiment, a hardware assembly is provided with a threaded handle for a drawer or door. A handle hardware fastener is provided with a threaded shaft for threaded engagement with the threaded handle, with a length to extend through an aperture formed through a drawer or door, wherein at least one weakened region is formed in the threaded shaft to permit separation of an unused portion of the shaft from an installed portion of the shaft. A head is attached to the threaded shaft, the head has a width greater than a diameter of the shaft. The threaded handle is sized to receive the threaded shaft in threaded engagement.

According to another embodiment, a handle hardware fastener is provided with a threaded shaft for threaded engagement with a threaded handle. A head is attached to the threaded shaft. The head has a first drive feature operable to be driven for rotation, a second drive feature operable to be driven for rotation, and a third drive feature operable to be driven for rotation.

According to a further embodiment, a washer is formed integrally with the head. The washer has a diameter greater than a diameter of the threaded shaft.

According to an even further embodiment, the head has a diameter greater than the diameter of the shaft and less than the diameter of the washer.

According to another further embodiment, the first drive feature is further defined as: a slot sized to receive a flat head screwdriver, a pair of slots sized to receive a Phillips head screwdriver, or an external spline formed about the head.

According to an even further embodiment, the second drive feature is different than the first drive feature. The second drive feature is further defined as: a slot sized to receive a flat head screwdriver, a pair of slots sized to receive a Phillips head screwdriver, or an external spline formed about the head.

According to another further embodiment, the third drive feature is different than the first drive feature and the second drive feature. The third drive feature is further defined as: a slot sized to receive a flat head screwdriver, a pair of slots sized to receive a Phillips head screwdriver, or an external spline formed about the head.

According to another embodiment, a hardware assembly is provided with a threaded handle for a drawer or door. A handle hardware fastener is provided with a threaded shaft for threaded engagement with the threaded handle. A head is attached to the threaded shaft. The head has a first drive feature operable to be driven for rotation, a second drive feature operable to be driven for rotation, and a third drive feature operable to be driven for rotation. The threaded handle is sized to receive the threaded shaft in threaded engagement.

According to an embodiment, a method to install hardware to a drawer or door is provided by installing a threaded shaft of a fastener through an aperture formed through a drawer or door. The threaded shaft is shortened at a weakened region outside of a threaded region adjacent the drawer or door. The threaded shaft is installed into threaded engagement with a handle.

According to a further embodiment, a head of the fastener is driven while the threaded shaft is installed into threaded engagement with the handle.

One general embodiment includes a handle hardware fastener that also includes a threaded shaft for threaded engagement with a threaded handle, with a length to extend through an aperture formed through a drawer or door, where at least one weakened region is formed in the threaded shaft to permit separation of an unused portion of the shaft from an installed portion of the shaft. The fastener also includes a head attached to the threaded shaft, the head having a width greater than a diameter of the shaft.

Other embodiments may include one or more of the following features. The handle hardware fastener where the at least one weakened region is further defined as a transverse notch formed in the threaded shaft. The fastener is formed from a structural polymer. The head provides a first drive feature operable to be driven for rotation, and a second drive feature operable to be driven for rotation. The head provides a third drive feature operable to be driven for rotation. The first drive feature is further defined as: a slot sized to receive a flat head screwdriver; a pair of slots sized to receive a Phillips head screwdriver; or an external spline formed about the head. The second drive feature is different than the first drive feature; and where the second drive feature is further defined as: a slot sized to receive a flat head screwdriver, a pair of slots sized to receive a Phillips head screwdriver, or an external spline formed about the head. The head provides a third drive feature operable to be driven for rotation; where the third drive feature is different than the first drive feature and the second drive feature; and where the third drive feature is further defined as: a slot sized to receive a flat head screwdriver, a pair of slots sized to receive a Phillips head screwdriver, or an external spline formed about the head. The handle hardware fastener may include a washer formed integrally with the head, the washer having a diameter greater than a diameter of the threaded shaft. The head has a diameter greater than the diameter of the shaft and less than the diameter of the washer. The threaded handle is sized to receive the threaded shaft in threaded engagement. The weakened region is further defined as only one weakened region.

One general embodiment includes a handle hardware fastener that also includes a threaded shaft for threaded engagement with a threaded handle. The fastener also includes a head attached to the threaded shaft, the head having a first drive feature operable to be driven for rotation, a second drive feature operable to be driven for rotation, and a third drive feature operable to be driven for rotation.

Other embodiments may include one or more of the following features. The handle hardware fastener may include a washer formed integrally with the head, the washer having a diameter greater than a diameter of the threaded shaft. The head has a diameter greater than the diameter of the shaft and less than the diameter of the washer. The first drive feature is further defined as: a slot sized to receive a flat head screwdriver; a pair of slots sized to receive a Phillips head screwdriver; or an external spline formed about the head. The second drive feature is different than the first drive feature; and where the second drive feature is further defined as: a slot sized to receive a flat head screwdriver, a pair of slots sized to receive a Phillips head screwdriver, or an external spline formed about the head. The third drive feature is different than the first drive feature and the second drive feature; and where the third drive feature is further defined as: a slot sized to receive a flat head screwdriver, a pair of slots sized to receive a Phillips head screwdriver, or an external spline formed about the head. The threaded handle is sized to receive the threaded shaft in threaded engagement.

One general embodiment includes a method to install hardware to a drawer or door. The method also includes installing a threaded shaft of a fastener through an aperture formed through a drawer or door. The method also includes shortening the threaded shaft at a weakened region outside of a threaded region adjacent the drawer or door. The method also includes installing the threaded shaft into threaded engagement with a handle.

### BRIEF DESCRIPTION OF THE DRAWINGS

FIG. 1 is a partial section view of a hardware assembly according to an embodiment;

FIG. 2 is a side perspective view of a handle hardware fastener of FIG. 1;

FIG. 3 is a side elevation view of the handle hardware fastener of FIG. 1;

FIG. 4 is another side perspective view of the handle hardware fastener of FIG. 1; and

FIG. 5 is a method to install hardware according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc., are, in some instances, used herein to describe various elements, these elements should not be limited by these terms. These terms are only used to distinguish one element from another and are presented in order of introduction for a particular embodiment, and may vary in the introduction of various embodiments. For example, a first drive feature could be termed a second drive feature, and, similarly, a second drive feature could be termed a first drive feature, without departing from the scope of the various described embodiments. The first drive feature and the second drive feature are both drive features, but they are not the same drive feature in the context of a particular embodiment.

Cabinet hardware is typically provided with a standard screw that only works with a certain range of cabinet or drawer thicknesses. Cabinet hardware is also provided with breakaway screws with multiple threaded regions spaced apart by unthreaded regions. The breakaway screws are often formed from a steel alloy. The prior art breakaway screws permit a user to break the screw at one of the unthreaded regions to remove an unneeded region. Due to the hardness of the steel alloy, the prior art breakaway screws are often difficult to break to remove an unneeded portion. Tools are often required to shorten prior art breakaway screws. The threads of a remaining region are often deformed, burred, or otherwise compromised in prior art breakaway screws due to deformation while breaking and removing the unneeded portion. The prior art breakaway screws often offer many break point options for various cabinet hardware applications.

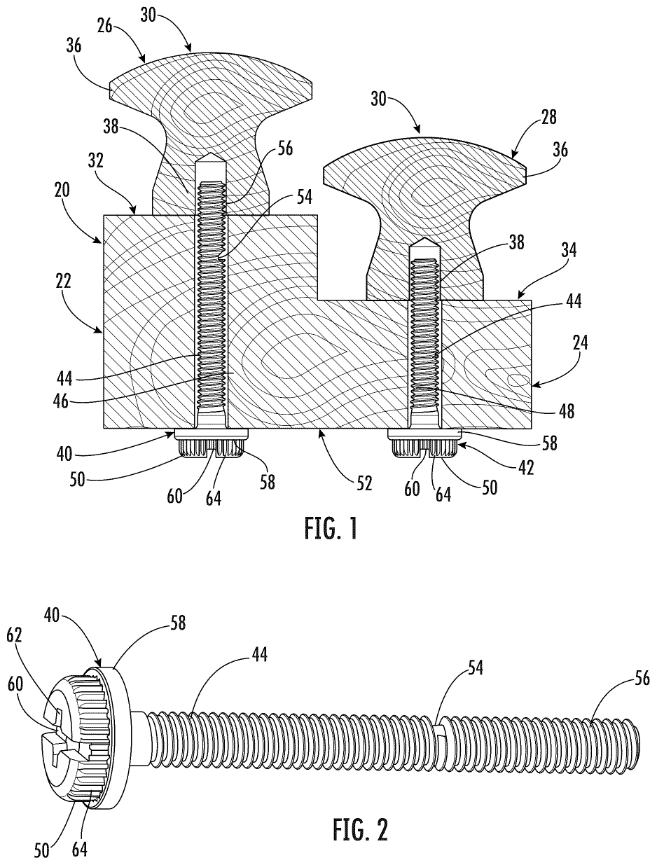

FIG. 1 illustrates a panel 20 of a drawer or door for a cabinet, furniture, or the like. The panel 20 includes various thicknesses 22, 24 for the sake of illustration, as it is common that different panels 20 are provided with different thicknesses 22, 24. The panel 20 is illustrated in combination with a plurality of hardware assemblies 26, 28 according to an embodiment. Each of the hardware assemblies 26, 28 is illustrated installed at a different thickness 22, 24 of the panel 20 to demonstrate the flexibility and adjustability of the hardware assemblies 26, 28.

The hardware assemblies 26, 28 are further defined as handle assemblies 26, 28 to assemble handles 30 to the panel 20. The handles 30 are assembled to exterior surfaces 32, 34 of the panel 20. The handles 30 have a body 36 that is sized and contoured for a user to grasp the handle 30 to slide, pivot, or otherwise move, the panel 20, and consequently the drawer or door. In the depicted embodiment, the handles 30 are knobs 30, which may have radial symmetry as depicted. According to another embodiment, the handles 30 are pull handles 30, which may have more than one connection to the panel 20.

As illustrated, the handle 30 includes a threaded region 38. According to an embodiment, the threaded region 38 is an internally threaded aperture 38 formed to a blind depth within the body 36 of the handle 30 for receipt of an externally threaded fastener.

Each handle assembly 26, 28 includes a handle hardware fastener 40, 42. The handle hardware fastener 40 is also illustrated in FIGS. 1-4. With reference to FIG. 1, each fastener 40, 42 includes a threaded shaft 44 that is sized to extend through a through aperture 46, 48 formed through the panel 20. The threaded shaft 44 is externally threaded for engagement within the threaded aperture 38 of the handle 30. The threaded shaft 44 is sized with a length to extend through panels 20 of different thicknesses, as demonstrated in FIG. 1.

The fasteners 40, 42 also each include a fastener head 50 to engage a back surface 52, or internal surface 52 of the panel 20 to fasten the handle 30 to the panel 20. The fastener head 50 has an outer width dimension, such as an outer diameter, that is greater than a diameter of the shaft 44 and the through apertures 46, 48 to engage the internal surface 52.

As illustrated in FIG. 1, the handle assemblies 26, 28 can be installed to panels 20 of varying thicknesses. Rather than providing threaded shafts 44 of different lengths, the handle assemblies 26, 28 include the threaded shaft 44 that can be shortened to different lengths. For example, as illustrated in FIGS. 1-4, the threaded shaft 44 includes at least one weakened region 54 to permit separation of a distal portion 56 of the threaded shaft 44 on the exterior surface 32, 34 of the panel 20 as an unused portion 56, separated from the installed portion 44. The fastener 42 illustrates the shaft 44 with the distal portion 56 removed. According to an embodiment, the weakened region 54 is a transverse notch 54 formed partially into the threaded shaft 44. To permit the threaded shaft 44 to be shortened to various lengths for varying panel 20 thicknesses, a plurality of incrementally spaced transverse notches 54 may be formed into the threaded shaft 44. The transverse notch 54 is spaced apart from the fastener head 50 so that the distal end 56 of the threaded shaft 44 can be removed at the exterior surface 32, 34 of the panel 20.

As illustrated in FIGS. 1-4, the fasteners 40, 42 include a washer 58 formed integrally with the fastener head 50. The washer 58 has an outer diameter greater than that of the fastener head 50 and the threaded shaft 44 to distribute loads from the fastener 40, 42 to the panel 20.

The fastener head 50 includes multiple drive features for convenience for installation, and disassembly. According to the depicted embodiment, the fastener head 50 includes three different drive features. For example, the fastener head 50 includes a single slot 60 formed transversely to a blind depth. The slot 60 is sized to receive a flat head screwdriver to provide a first drive feature for imparting a rotation to, or resisting a rotation from, the fastener 40, 42. During installation, the installer may employ a flat head screwdriver to engage the slot 60 and drive the fastener 40, 42 for rotation relative to the handle 30, or to resist rotation as the user imparts rotation to the handle 30.

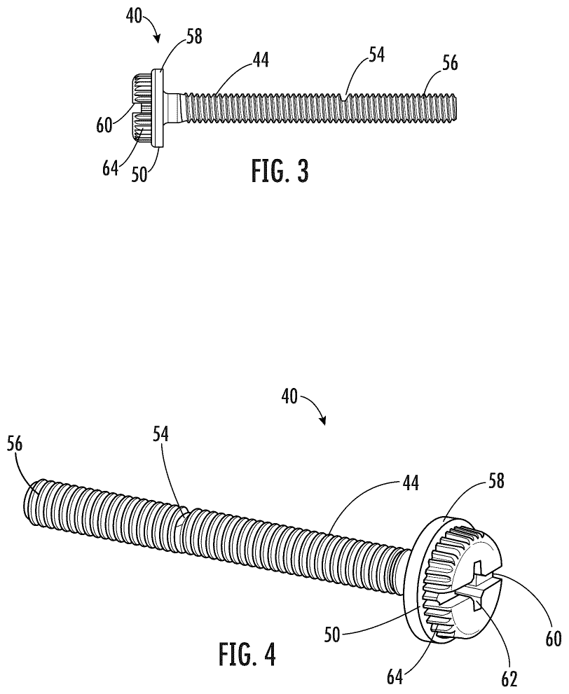

The second drive feature is illustrated in FIGS. 2 and 4, and includes a pair of intersecting slots 60, 62 sized to receive a head of a Phillips head screwdriver. The pair of slots 60, 62, may include the flat head drive slot 60 in combination with the narrower width intersecting slot 62. As illustrated in FIGS. 1-4, the third drive feature includes an external spline 64 formed about the fastener heads 50. The external spline 64 permits an installer to manually rotate the fastener 40, 42 to fasten the handle 30 to the panel 20. Although the outer perimeter of the head 50 is illustrated with fine grooves or splines, the head may be provided with wrench flats for cooperation with a wrench, knurling for finger handling and tightening, or the like.

The handle assemblies 26, 28 of FIG. 1 provides handle assemblies 26, 28 that accommodate a range of consumer needs by permitting installation in a range of thicknesses of the panel 20 of the cabinets or drawers on which knobs 30 or pulls 30 can be installed. The handle assemblies 26, 28 also alleviate some of the shortcomings and customer frustrations of prior art breakaway fastener arrangements.

The handle assemblies 26, 28 features the threaded shaft 44 with notches 54, which may be cuts perpendicular to a lengthwise axis of the shaft 44, to design the locations of breakaway points. This feature allows for the installer or consumer to snap the shaft 44 down to one of a few predetermined lengths.

According to one embodiment, the fasteners 40, 42 are provided from a structural polymer. For example, the material may be a glass fiber reinforced Nylon, which is sturdy yet readily snapped or sheared upon a transverse manual load. The material in combination with the transverse notch 54 permits deformation and breakage at the weakened region 54 without compromising the threads of the shaft 44. The glass fiber fill of the material may be thirty to forty percent, according to some embodiments. The notch 54 may be formed in one radial region instead of a full circumference, which is susceptible to transverse loads for breakage, while resilient to tensile loads associated with the tightening of the fastener 40.

The combination drive breakaway screw 40 supplies multiple conveniences for a consumer when installing cabinet hardware, and is conducive to non-standard materials such as plastic composites or reinforced composites.

The breakaway feature allows a single screw 40 to cater to a wider range of consumers, as cabinet thicknesses can vary in the market. The combination drives of the fastener head 50 ensure that a consumer is more likely to have a tool to tighten the screw 40. The combination drives provide a failsafe in case one of the drives become stripped or damaged (especially when constructed from a softer material than a prior art steel alloy). The splined 64 fastener head 50 permits installation without tools.

The combination drive breakaway fastener 40 features the geometry of a standard breakaway fastener (one or more “notches” along the threaded shaft 44 of the screw 40 to aid in snapping to a shorter, predefined length if necessary for the application) and a combination drive fastener head 50 (with drive features of: Phillips head, Flat head, and a grooved perimeter for hand-tightening).

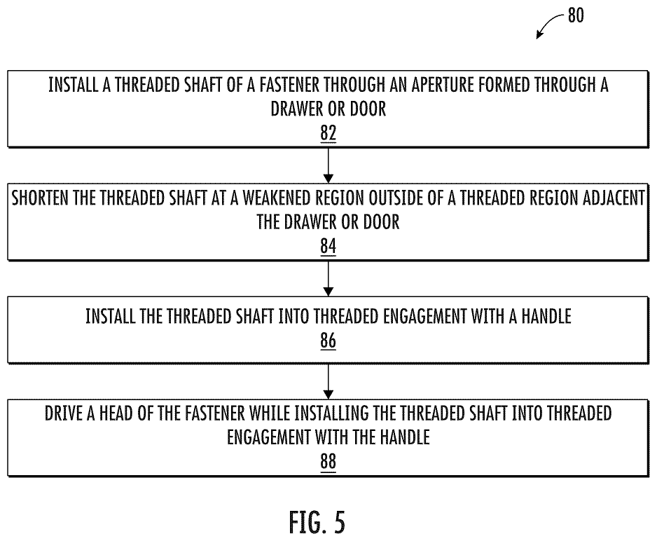

FIG. 5 illustrates a method 80 to install hardware to a drawer or door. At step 82, the threaded shaft 44 of the fastener 40 is installed through the aperture 46, 48 formed through the panel 20 of the drawer or door. The user may determine whether the threaded shaft 44 extends significantly beyond the exterior surface 34 of the panel 20. In other words, if the notch 54 is spaced apart from the exterior surface 34 exposing multiple threads of the threaded shaft 44 between the notch 54 and the exterior surface 34, then at step 84, the threaded shaft 44 is shortened at the weakened region 54 outside of the threaded region 44 adjacent panel 20 of the drawer or door. The removed distal portion 56 is discarded. If the notch 54 is not spaced apart from the exterior surface 32 exposing threads of the shaft 44, then the shaft 44 is not shortened.

At step 86, the threaded shaft 44 is driven into threaded engagement with the handle 30. The head 50 of the fastener 40, 42 is driven while installing the threaded shaft 44 into threaded engagement with the handle 30 at step 88.

The threaded shaft 44 may be provided with a single break point 54 for a clear distinction of application, such as when two lengths are common, such as a drawer handle assembly 26, and a cabinet handle assembly 28. The break point 54 may be spaced apart from a common thickness 24, such as three-quarters of an inch. The length of the unbroken shaft 44 may be sufficient to extend beyond a common cabinet face thickness 22 of one and a quarter inches.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A handle hardware fastener comprising:
a threaded shaft for threaded engagement with a threaded handle, with a length to extend through an aperture formed through a drawer or door, wherein a weakened region is formed in the threaded shaft to permit separation of an unused portion of the threaded shaft from an installed portion of the threaded shaft; and
a head attached to the threaded shaft, the head having a width greater than a diameter of the shaft.

2. The handle hardware fastener of claim 1, wherein the weakened region is further defined as a transverse notch formed in the threaded shaft.

3. The handle hardware fastener of claim 1, wherein the fastener is formed from a structural polymer.

4. The handle hardware fastener of claim 1, wherein the head provides a first drive feature operable to be driven for rotation, and a second drive feature operable to be driven for rotation.

5. The handle hardware fastener of claim 4 wherein the head provides a third drive feature operable to be driven for rotation.

6. The handle hardware fastener of claim 4, wherein the first drive feature is further defined as:
a slot sized to receive a flat head screwdriver;
a pair of slots sized to receive a Phillips head screwdriver; or
an external spline formed about the head.

7. The handle hardware fastener of claim 6, wherein the second drive feature is different than the first drive feature; and
wherein the second drive feature is further defined as:
a slot sized to receive a flat head screwdriver,
a pair of slots sized to receive a Phillips head screwdriver, or
an external spline formed about the head.

8. The handle hardware fastener of claim 7, wherein the head provides a third drive feature operable to be driven for rotation;
wherein the third drive feature is different than the first drive feature and the second drive feature; and
wherein the third drive feature is further defined as:
a slot sized to receive a flat head screwdriver,
a pair of slots sized to receive a Phillips head screwdriver, or
an external spline formed about the head.

9. The handle hardware fastener of claim 1, further comprising a washer formed integrally with the head, the washer having a diameter greater than a diameter of the threaded shaft; and
wherein the head has a diameter greater than the diameter of the shaft and less than the diameter of the washer.

10. The handle hardware fastener of claim 1, wherein the weakened region is further defined as one or more weakened regions.

11. A hardware assembly comprising:
a threaded handle for a drawer or door; and
the handle hardware fastener of claim 1, wherein the threaded handle is sized to receive the threaded shaft in threaded engagement.

12. A handle hardware fastener comprising:
a threaded shaft for threaded engagement with a threaded handle; and
a head attached to the threaded shaft, the head having a first drive feature operable to be driven for rotation, a second drive feature operable to be driven for rotation, and a third drive feature operable to be driven for rotation.

13. The handle hardware fastener of claim 12, further comprising a washer formed integrally with the head, the washer having a diameter greater than a diameter of the threaded shaft.

14. The handle hardware fastener of claim 13, wherein the head has a diameter greater than the diameter of the shaft and less than the diameter of the washer.

15. The handle hardware fastener of claim 12, wherein the first drive feature is further defined as:
a slot sized to receive a flat head screwdriver;
a pair of slots sized to receive a Phillips head screwdriver; or
an external spline formed about the head.

16. The handle hardware fastener of claim 15, wherein the second drive feature is different than the first drive feature; and
wherein the second drive feature is further defined as:
a slot sized to receive a flat head screwdriver,
a pair of slots sized to receive a Phillips head screwdriver, or
an external spline formed about the head.

17. The handle hardware fastener of claim 16, wherein the third drive feature is different than the first drive feature and the second drive feature; and
wherein the third drive feature is further defined as:
a slot sized to receive a flat head screwdriver,
a pair of slots sized to receive a Phillips head screwdriver, or
an external spline formed about the head.

18. A hardware assembly comprising:
a threaded handle for a drawer or door; and
the handle hardware fastener of claim 12, wherein the threaded handle is sized to receive the threaded shaft in threaded engagement.

19. A method to install hardware to a drawer or door, the method comprising:
installing a threaded shaft of a fastener through an aperture formed through a drawer or door;
shortening the threaded shaft at a weakened region outside of a threaded region adjacent the drawer or door; and
installing the threaded shaft into threaded engagement with a handle.

20. The method of claim 19 further comprising driving a head of the fastener while installing the threaded shaft into threaded engagement with the handle.
